(19) United States
(12) Patent Application Publication
(10) Pub. No.: US 2008/0111415 A1
(43) Pub. Date: May 15, 2008

(54) SMARTFOLD ACTUATOR FOR MECHANISM

(75) Inventors: John F. Nathan, Highland Township, MI (US); H. Winston Maue, Northville, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: Lear Corporation, Southfield, MI (US)

(21) Appl. No.: 11/559,531

(22) Filed: Nov. 14, 2006

(51) Int. Cl. B60N 2/44

(52) U.S. Cl. 297/378.12

(57) ABSTRACT

An actuator assembly for use with a seat assembly having a latch assembly, the latch assembly having a handle portion and a latch release mechanism connected to the handle portion, the latch release mechanism controlling movement of one portion of the seat assembly with respect to another portion of the seat assembly, the latch release mechanism being manually operable by the handle portion, the actuator assembly having a base plate adapted to be positioned on the seat assembly proximate the latch release mechanism and an actuator assembly connected to the base plate and positioned so as to be capable of engaging the latch release mechanism, the actuator assembly being configured to avoid obstructing manual operation of the latch assembly.

### BACKGROUND OF THE INVENTION

1. Field of the Invention

The present invention relates to seat fold actuators.

2. Background Art

Latches are devices that can be used to grasp or secure an object. Latches may be used to secure a vehicle seat back in an upright position. Actuators are devices that can cause an apparatus to operate. An actuator may be used to release a latch. Some actuators may be remotely triggered and, if coupled with a latch, permit an operator to release the latch from a distance.

Some latches can be manually released by an operator through the use of a handle or lever that acts on a release mechanism. It is desirable to have a remotely triggered actuator actuate the same release mechanism that is actuated by the handle rather than an actuator that indirectly actuates the mechanism. This is because the force required to directly actuate the release mechanism may be less than the force required to indirectly actuate the mechanism. However, actuators that actuate the release mechanism directly may obstruct or otherwise interfere with manual operation of the latch.

### SUMMARY OF THE INVENTION

Under the present invention, an actuator assembly is provided for use with a seat assembly that has a latch assembly. The latch assembly has a handle portion and a latch release mechanism configured to move between a locked position and a released position. The latch assembly prevents movement of one portion of the seat assembly with respect to another portion of the seat assembly when the latch release mechanism is in the locked position and permits movement of the one portion of the seat assembly with respect to the other portion of the seat assembly when the latch release mechanism is in the released position. The latch released mechanism may be manually operable by the handle portion. In a first embodiment, the actuator assembly of the present invention includes a base plate that is adapted to be positioned on the seat assembly proximate the latch release mechanism and an actuator connected to the base plate. The actuator is capable of moving the latch release mechanism from the locked position to the released position. The actuator is also configured to avoid obstructing manual operation of the latch assembly by the handle.

In at least one implementation of the first embodiment, the actuator is adapted to engage the vehicle seat assembly as the one portion of the seat assembly moves with respect to the other portion of the seat assembly such that the latch assembly can be reset.

In at least another implementation of the first embodiment, the actuator includes a component connected to the actuator that is configured to move back and forth between a cocked position and a fired position. The component is configured to engage the latch release mechanism such that the component moves the latch release mechanism from the locked position to the released position as the component moves from the cocked position to the fired position. In at least one variation of this implementation, the component is adapted to engage the vehicle seat assembly as the one portion of the seat assembly moves with respect to the other portion of the seat assembly such that the component is moved from the fired position to the cocked position. In at least another variation of this implementation, the latch release mechanism has a ridge along a perimeter of the latch release mechanism and the component has a tooth capable of engaging the ridge. The component is capable of moving the latch release mechanism from the locked position to the released position by cooperation of the tooth and the ridge.

In at least another implementation of the first embodiment, the actuator assembly further includes an elongated linkage attached to the actuator to enable remote actuation of the actuator.

In a second embodiment of the present invention, a vehicle seat assembly in combination with an actuator assembly is provided. The seat assembly has a seat back, a seat bottom connected to the seat back, and a latch assembly connected to the seat back. The latch assembly has a handle portion and a latch release mechanism configured to move between a locked position and a released position. The latch assembly prevents movement of the seat back with respect to the seat bottom when the latch release mechanism is in the locked position. The latch assembly permits movement of the seat back with respect to the seat bottom when the latch release mechanism is in the released position. The latch release mechanism may be manually operated by the handle portion. The actuator assembly is connected to the seat assembly and includes a base plate that is connected to the seat assembly in proximity to the latch release mechanism. The actuator assembly also includes an actuator connected to the base plate. The actuator moves the latch release mechanism from the locked position to the released position when the actuator is actuated. The actuator is configured to avoid obstructing manual operation of the latch assembly by the handle.

In at least one implementation of the second embodiment, the seat assembly further includes a cocking member connected to the seat assembly wherein the cocking member engages the actuator as the seat back moves with respect to the seat bottom such that the latch assembly is reset. In at least one variation of this implementation, the actuator includes a component that is connected to the actuator that is configured to move back and forth between a cocked position and a fired position. The component is configured to engage the latch release mechanism such that the component moves the latch release mechanism from the locked position to the released position as the component moves from the cocked position to the fired position. In at least a further variation of this implementation, the latch release mechanism has a ridge along a perimeter of the latch release mechanism and the component has a tooth capable of engaging the ridge. The component moves the latch release mechanism from the locked position to the released position by cooperation of the tooth and the ridge. In a further variation of this implementation, the actuator assembly further includes an elongated linkage attached to the actuator that enables remote actuation of the actuator. Additionally, the component includes a protrusion which engages the cocking member as the seat back moves with respect to the seat bottom such that the cocking member on the protrusion cooperate to move the component from the fired position to the cocked position.

In a third embodiment of the present invention, an actuator assembly is provided for use with a vehicle seat assembly having a seat bottom, a seat back connected to the seat bottom, a spring connected to the vehicle seat assembly urging one portion of the vehicle seat assembly to move with respect to another portion of the vehicle seat assembly, and a latch assembly connected to the vehicle seat assembly to restrict such movement. In at least this third embodiment, the actuator comprises a base plate that is attachable to the vehicle seat assembly and that can be positioned over the latch assembly. The actuator assembly further comprises a reference plate that is connected to the base plate. The actuator assembly further includes a power plate positioned adjacent a side of the reference plate and proximate the latch assembly when the base plate is positioned over the latch assembly. The power plate is configured for movement with respect to the reference plate between a cocked position and a fired position. The power plate may be configured to avoid obstructing manual operation of the latch assembly. The actuator assembly further includes a power spring that engages the power plate and urges the power plate towards the fired position. The actuator assembly further includes a trigger plate positioned adjacent to another side of the reference plate and configured for movement with respect to the reference plate between a hold position and a release position. The actuator assembly further includes a trigger spring engaging the trigger plate and urging the trigger plate towards the hold position. In this third embodiment, the power plate is inhibited from moving to the fired position when the trigger plate is in the hold position. The power plate moves from the cocked position to the fired position and is retained in the fired position by the power spring when the trigger plate is in the release position. The power plate is capable of engaging the latch assembly and causing the latch assembly to release when the power plate moves from the cocked position to the fired position. The power plate is capable of retaining the latch assembly in a released state while the power plate is in the fired position.

In at least one implementation of the third embodiment, the vehicle seat assembly has a cocking member. A portion of the power plate is capable of engaging the cocking member as one portion of the vehicle seat assembly moves with respect to another portion of the vehicle seat assembly such that the power plate can be returned to the cocked position. In at least one variation of this implementation, the power plate has a protrusion capable of engaging the cocking member whereby the power plate can be returned to the cocked position by cooperation of the cocking member and the protrusion.

In at least another implementation of the third embodiment, where the latch assembly has a latch release member configured for movement between a locked position and a released position, and where the latch assembly further includes a handle connected to the latch release member to permit manual operation of the latch assembly, the base plate is capable of being positioned over the latch release member, the power plate is capable of engaging the latch release member to move the latch release member between the locked position and the released position and the power plate is configured to avoid obstruction of manual operation of the latch assembly. In at least one variation of this implementation, the latch release member has a ridge disposed along a perimeter of the latch release member. The power plate has a tooth that is capable of cooperating with the ridge to move the latch release member from the locked position to the released position when the power plate moves from the cocked position to the fired position.

In at least another implementation of the third embodiment, the actuator assembly further comprises an extending member connected to the power plate, the extending member being positioned inboard of the power plate with respect to the latch assembly and being capable of engaging the latch assembly and causing the latch assembly to release when the power plate moves from the cocked position to the fired position.

In at least another implementation of the third embodiment, the actuator assembly further comprises a ball bearing. The reference plate includes an aperture and the ball bearing is at least partially received within the aperture. The power plate includes a power plate ball bearing receptacle for at least partially receiving the ball bearing and wherein the trigger plate includes a trigger plate ball bearing receptacle for at least partially receiving the ball bearing. The power plate ball bearing receptacle has an incline that urges the ball bearing out of the power plate ball bearing receptacle as the power plate moves from the cocked position to the fired position. The trigger plate ball bearing receptacle has an incline that urges the ball bearing out of the trigger plate ball bearing receptacle as the trigger plate moves from the released position to the hold position. The ball bearing is free to at least partially move between the power plate ball bearing receptacle and the trigger plate ball bearing receptacle when the power plate ball bearing receptacle and the trigger plate ball bearing receptacle are both substantially aligned with the ball bearing aperture. The trigger plate ball bearing receptacle and the power plate ball bearing receptacle are both substantially aligned with the ball bearing aperture when the power plate is in the cocked position and the trigger plate is in the release position. The ball bearing is positioned at least partially between the power plate ball bearing receptacle and the ball bearing aperture thereby obstructing movement of the power plate from the cocked position to the fired position when the trigger plate is in the hold position and wherein the ball bearing is positioned at least partially between the trigger plate ball bearing receptacle and the ball bearing aperture thereby preventing movement of the trigger plate from the release position to the hold position when the power plate is in the fired position.

In at least another implementation of the third embodiment, the actuator assembly further comprises a tether connected to the trigger plate such that the trigger plate moves from the hold position to the release position when the tether is pulled. In at least one variation of this implementation, the tether includes a cable assembly comprising a cable mounted inside of a sleeve. The cable is capable of moving with respect to the sleeve and the cable is connected to the trigger plate.

### BRIEF DESCRIPTION OF THE DRAWINGS

FIG. 1A is a perspective view of an embodiment of a vehicle seat assembly equipped with an embodiment of the actuator of the present invention;

FIG. 1B is a perspective, cut away, fragmentary view of the vehicle seat of FIG. 1A;

FIG. 2A is a portion of an exploded view of the actuator of FIG. 1;

FIG. 2B is the remainder of the exploded view of the actuator of FIG. 1;

FIG. 2C is a perspective view of a base plate;

FIG. 2D is a perspective view of a trigger plate;

FIG. 3 is a perspective view of the actuator of FIG. 1;

FIG. 4 is a bottom elevational view of the actuator of FIG. 1;

FIG. 5A is a fragmentary cross sectional view of the base plate, the trigger plate and a reference plate in a first configuration;

FIG. 5B is a fragmentary cross sectional view of the base plate, the trigger plate, and the reference plate in a second configuration;

FIG. 5C is a fragmentary cross sectional view of the base plate, the trigger plate, and the reference plate in a third configuration;

FIG. 6A is a fragmentary side elevational view of the seat assembly and the actuator assembly of FIG. 1 in a first configuration;

FIG. 6B is a fragmentary side elevational view of the seat assembly and actuator assembly of FIG. 1 in a second configuration;

FIG. 6C is a fragmentary side elevational view of the seat assembly and actuator assembly of FIG. 1 in a third configuration;

FIG. 6D is a fragmentary side elevational view of the seat assembly and the actuator assembly of FIG. 1 in a fourth configuration;

FIG. 7 is a side elevational view of a latch release mechanism;

FIG. 8 is a fragmentary side elevational view of the latch mechanism and the power plate in a cocked position over the latch release mechanism;

FIG. 9 is a fragmentary side elevational view of the power plate in the cocked position with the latch release mechanism in the release position.

### DETAILED DESCRIPTION OF THE PREFERRED EMBODIMENT(S)

Reference will now be made in detail to the illustrated embodiments of the present invention which constitute the best modes of practicing the invention presently known to the inventors. The following descriptions are merely exemplary in nature and in no way intended to limit the invention, its application, or uses. The figures are not necessarily drawn to scale. Therefore, specific details disclosed herein are not to be interpreted as limiting, but merely as a representative basis for any aspect of the invention and/or as a representative basis for teaching one skilled in the art to variously employ the present invention.

At least one solution to the problems set forth above includes an actuator, such as the one described in copending U.S. patent application Ser. No. 11/472,203 filed on Jun. 21, 2006 incorporated herein by reference, having an adaptation which permits the actuator to be mounted to a vehicle seat assembly in proximity to a latch release mechanism. The actuator can then directly release the latch that restrains the seat assembly from movement. In many applications, the force needed to directly actuate the latch release mechanism is lower than the force that would be needed to indirectly actuate the latch release mechanism. Advantages of a lower force requirement include the ability to manufacture actuators that may be smaller, lighter and/or less expensive to produce. Also, the force exerted by a user can be less, making the actuator easier to trigger.

In at least one embodiment, the actuator does not obstruct manual operation of the latch release mechanism thus giving a user the option to either manually operate the release mechanism or remotely actuate the release mechanism. Further, in at least one embodiment of the present invention, when the release mechanism is released and one portion of the vehicle seat assembly moves with respect to another portion of the vehicle seat assembly, that motion can be used to reset the actuator. Additionally, the actuator may be adapted for remote operation such as through the use of a tether or cable. In this manner, a button, lever, latch or other trigger mechanism may be positioned at a location remote from the actuator. Such remote positioning of the trigger mechanism can be advantageous because it would allow a user to actuate the latch release mechanism from a position that may be more accessible and/or easier to operate.

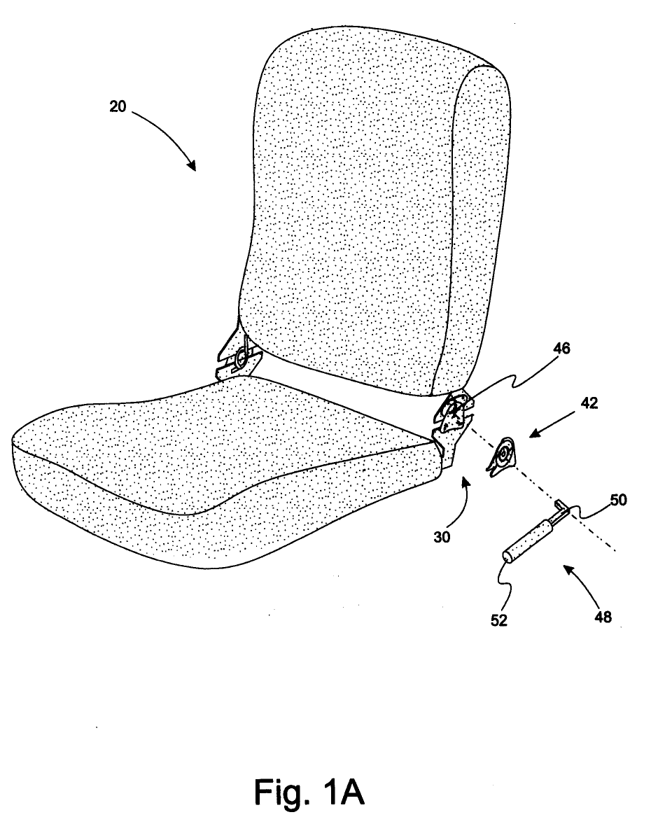

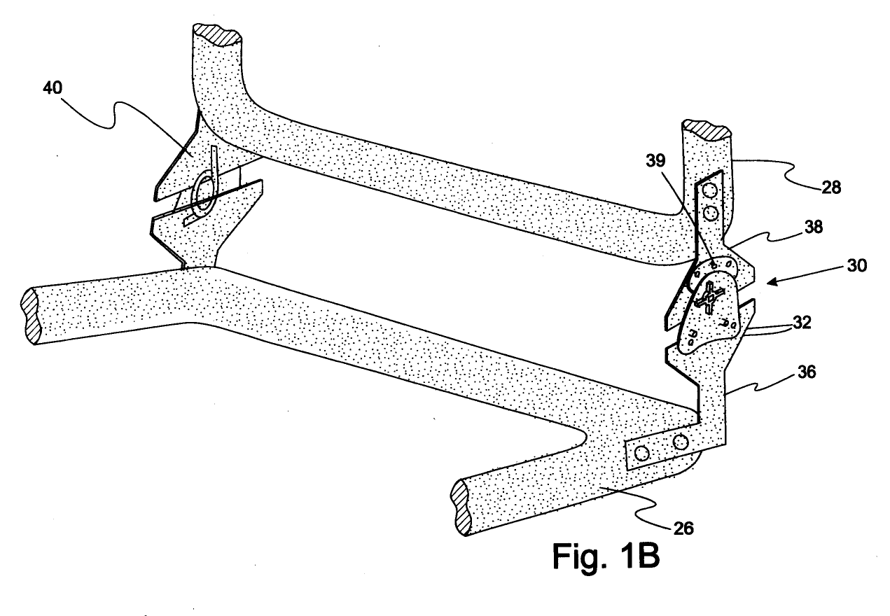

A preferred embodiment of the present invention and its operation is illustrated in FIGS. 1-9. FIGS. 1A and 1B illustrate vehicle seat assembly 20 equipped with an embodiment of an actuator assembly made in accordance with the teachings of the present invention. The vehicle seat assembly 20 may be mounted in any vehicle including an airplane, boat, train, and is preferably mounted in an automotive vehicle.

As illustrated in FIGS. 1A and 1B, vehicle seat assembly 20 includes a seat back assembly 22 and a seat bottom 24. Seat back assembly 22 can fold forward and rest flat against seat bottom 24. Vehicle seat assembly 20 can then tumble forward. Seat bottom 24 includes a seat bottom frame 26. Seat back assembly 22 includes seat back frame 28. The vehicle seat assembly 20 also includes latch assembly 30. Latch assembly 30 locks seat back assembly 22 in an upright position and inhibits the seat back assembly 22 from folding forward onto seat bottom 24. When latch assembly 30 is released, the seat back assembly 22 is free to fold over onto seat bottom 24.

As illustrated, latch assembly 30 includes two actuator positioning bosses 32. In other embodiments, one actuator positioning boss may be utilized. In still other embodiments, three or more actuator positioning bosses may be utilized. Actuator positioning bosses 32 can facilitate the positioning of an actuator over the latch assembly 30 to ensure proper alignment of the actuator with latch assembly 30.

Latch assembly 30 further includes latch release mechanism 34. Latch release mechanism 34 can release latch assembly 30 when latch release mechanism 34 is rotated in a clockwise direction when viewed in FIGS. 1A and 1B. Latch release mechanism 34 includes a plurality of ridges 35 disposed around a perimeter of latch release mechanism 34. As illustrated, latch assembly 30 is connected to vehicle seat assembly 20 by its connection to seat bottom frame bracket 36 and seat back frame bracket 38. In other embodiments, latch assembly 30 may be connected directly to seat bottom frame 26 and/or to seat back frame 28 or to other parts of seat back assembly 22 and/or seat bottom 24. As illustrated in FIGS. 1A and 1B, latch assembly 30 also includes a cocking member 39. Latch release mechanism has an opening 46 to receive a handle for manual operation.

The vehicle seat assembly 20 further includes vehicle seat spring 40. Vehicle seat spring 40 urges the vehicle seat back assembly 22 to fold towards vehicle seat bottom 24. When locked, latch assembly 30 prevents such rotation. When latch assembly 30 is released, seat back assembly 22 folds forward onto vehicle seat bottom 24 under the urging of vehicle seat spring 40.

Also depicted in FIGS. 1A and 1B is actuator assembly 42. As indicated by the broken line in FIG. 1A, the actuator assembly 42 may be positioned over latch assembly 30. Actuator assembly 42 may be properly aligned with latch assembly 30 through the use of the actuator positioning bosses 32. When actuator assembly 42 is properly aligned with latch assembly 30, an aperture in the actuator assembly 42 is axially aligned with opening 46 in latch release mechanism 34.

Also illustrated in FIG. 1A is handle assembly 48. Handle assembly 48 includes coupling portion 50 and a handle portion 52. Coupling portion 50 can be configured to conform to opening 46 in latch release mechanism 34 such that when an operator pulls on handle portion 52, coupling portion 50 engages an internal surface or surfaces of opening 46 and transmits torque to latch release mechanism 34 thereby rotating latch release mechanism 34. As indicated in FIG. 1, the coupling portion 50 can be inserted through an aperture in the actuator assembly 42 and received within opening 46.

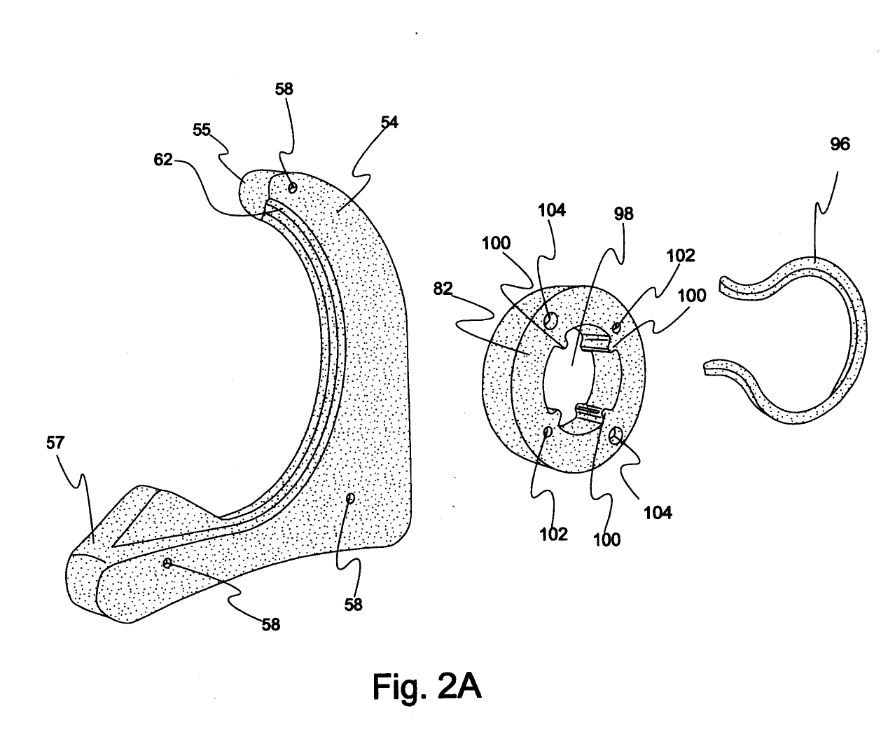

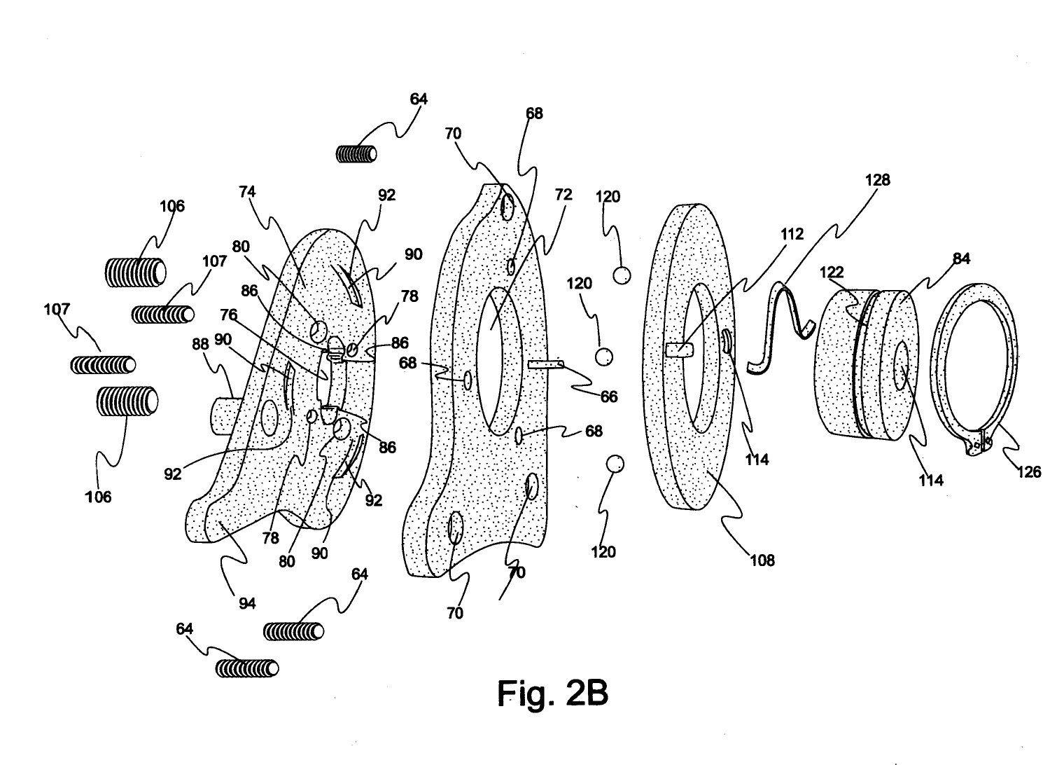

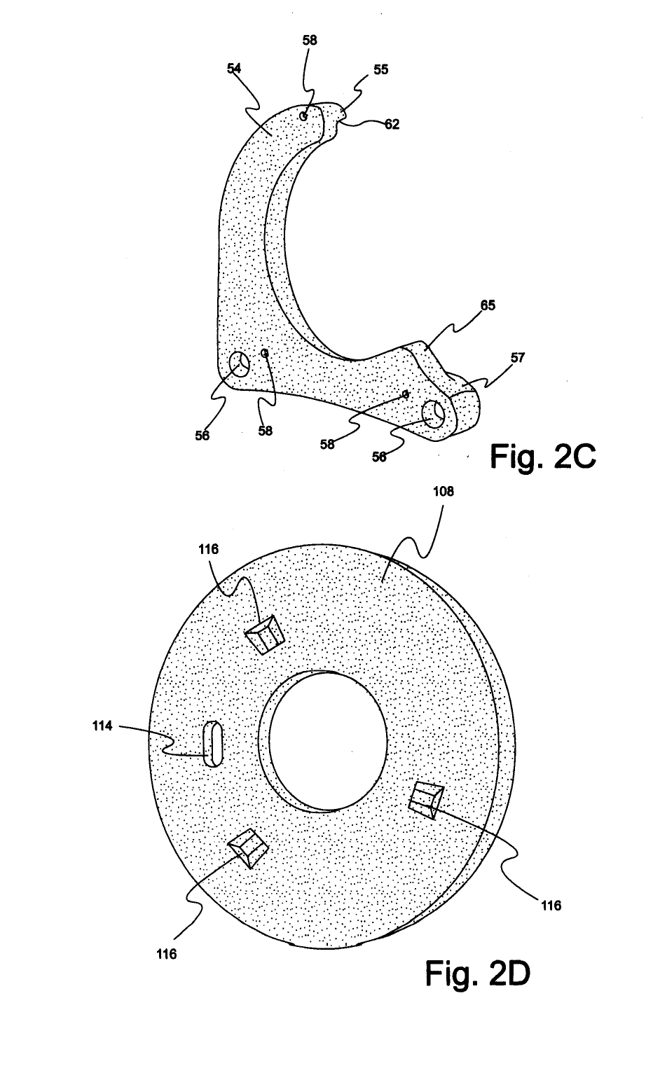

FIG. 2A illustrates an exploded view of the embodiment of actuator assembly 42 shown in FIG. 1. Actuator assembly 42 includes base plate 54. Base plate 54 is mounted to the latch assembly 30. As illustrated in FIG. 2B, base plate 54 has two positioning boss receiving apertures 56 positioned on an inboard portion of base plate 54. The positioning boss receiving apertures 56 serve as receivers for the actuator positioning bosses 32 and ensure that actuator assembly 42 is properly positioned on latch assembly 30. In other embodiments, base plate 54 may have actuator positioning bosses and latch assembly 30 may have positioning boss receiving apertures. In still other embodiments, base plate 54 may have both actuator positioning bosses and positioning boss receiving apertures and latch assembly 30 may have corresponding boss receiving apertures and actuator positioning bosses.

FIG. 2B illustrates the inboard side of base plate 54. Base plate 54 has three reference plate mounting apertures 58 for mounting reference plate 60 (See FIG. 2A) to base plate 54. Base plate 54 additionally has a power plate channel 62 which forms two sides of a groove that is formed when reference plate 60 is fastened to base plate 54. Base plate 54 further includes power spring brace 65 to engage the power spring (discussed below). Base plate 54 also includes a base plate upper end 55 and base plate lower end 57. Base plate 54 can be made from a material comprising steel, aluminum, a hybrid nylon glass filled or any other material that satisfies strain and stress requirements of a particular application.

As illustrated in FIG. 2A, reference plate 60 is mounted to the outboard side of base plate 54 and is secured to base plate 54 by reference plate fasteners 64. In the illustrated embodiment, three reference plate fasteners 64 are utilized. In other embodiments, greater or fewer fasteners may be used. When reference plate 60 is secured to base plate 54, a portion of the inboard side of reference plate 60 is positioned adjacent power plate channel 62, forming a groove. Reference plate 60 further includes reference plate boss 66 which protrudes in an outboard direction from the outboard side of reference plate 60. In the illustrated embodiment, reference plate 60 further includes reference plate ball bearing apertures 68 that extend through reference plate 60 from the outboard surface to the inboard surface. Reference plate 60 further includes base plate mounting apertures 70 which are in register with the reference plate mounting apertures 58 on base plate 54 when reference plate 60 is positioned on base plate 54. Fasteners 64 can be used to secure reference plate 60 to base plate 54. Reference plate 60 further includes a reference plate central axis aperture 72 extending from an outboard surface of reference plate 60 through to an inboard surface of reference plate 60. Preferably, reference plate central axis aperture 72 is generally circular. Reference plate 60 can be made from a material comprising steel, aluminum, a hybrid nylon glass filled or any other material that satisfies strain and stress requirements of a particular application.

Power plate 74 is positioned adjacent to the inboard side of reference plate 60 such that a portion of an outer perimeter of power plate 74 is disposed within the groove formed by the power plate channel 62 and reference plate 60. Power plate 74 includes a power plate central axis aperture 76 extending from the outboard surface of the power plate 74 through to the inboard surface of power plate 74. When power plate 74 is positioned adjacent reference plate 60 and within the groove formed by reference plate 60 and the power plate channel 62, the power plate central axis aperture 76 is axially aligned with the reference plate central axis aperture 72. In the illustrated embodiment, the power plate central axis aperture 76 has a smaller diameter than the reference plate central axis aperture 72.

In the illustrated embodiment, the power plate 74 further includes two power plate extension mounting apertures 78 extending from the inboard surface of the power plate 74 through to the outboard surface. In other embodiments, the power plate 74 may have a lesser or greater number of power plate extension mounting apertures.

The power plate extension mounting apertures 78 are provided to receive fasteners which fasten power plate extension 82 (addressed below) to the inboard side of power plate 74. Power plate 74 further has two trigger plate retaining assembly mounting apertures 80 extending from the outboard surface of power plate 74 through to the inboard surface. The trigger plate retaining member mounting apertures 80 in power plate 74 are provided to receive fasteners which may be used to fasten trigger plate retaining member 84 to the outboard side of power plate 74 (discussed below).

Power plate 74 further includes power plate teeth 86 positioned along the perimeter of the power plate central axis aperture 76. In the illustrated embodiment, power plate 74 has four power plate teeth 86. In other embodiments, power plate 74 may have a greater or lesser number of power plate teeth 86. Power plate 74 further includes a power plate boss 88 protruding in an inboard direction from an inboard surface of power plate 74.

Power plate 74 has three power plate ball bearing receptacles 90 disposed within the outboard surface of power plate 74. Each power plate ball bearing receptacle 90 has a power plate ball bearing receptacle incline 92. In the illustrated embodiment, each power plate ball bearing receptacle incline 92 ramps upwards towards the outboard surface of the power plate 74 in a counterclockwise direction when viewed in FIG. 2A. In other embodiments, the power plate ball bearing receptacle inclines 92 may ramp in other directions.

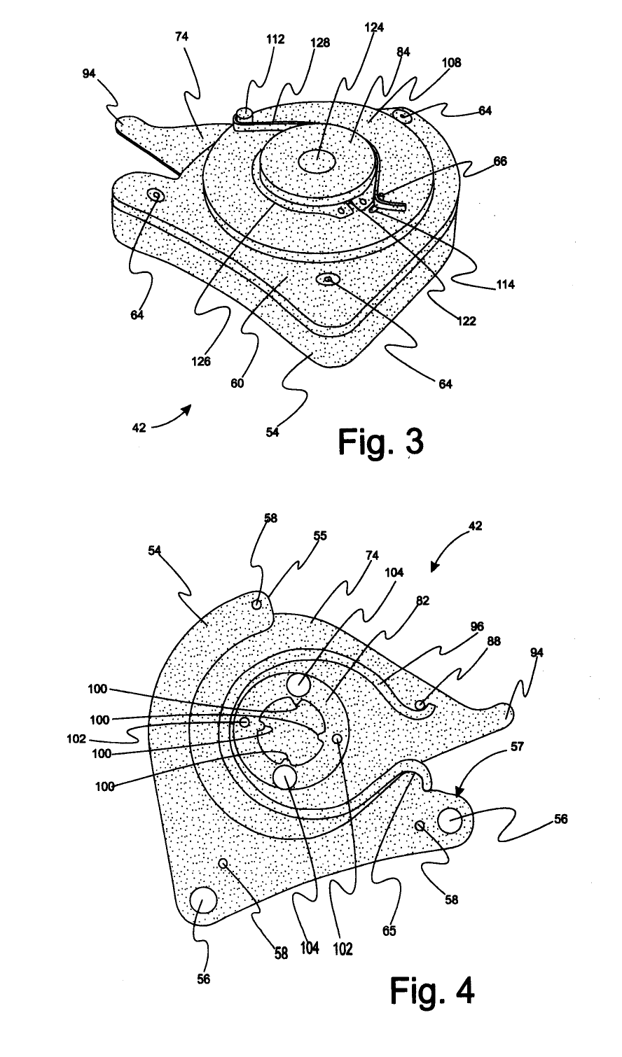

Power plate 74 further includes a power plate protrusion 94 extending in a direction away from the power plate central axis aperture 76 along a plane that is coplanar with power plate 74. When power plate 74 is positioned adjacent reference plate 60 and positioned within the groove formed by power plate channel 62 and reference plate 60, the power plate protrusion 94 extends beyond the edge of reference plate 60 when viewed perpendicularly to reference plate 60 (See FIG. 3).

When power plate 74 is positioned in the groove formed by power plate channel 62 and reference plate 60, it can rotate with respect to base plate 54 and reference plate 60 between the point where the power plate protrusion 94 is obstructed by the base plate lower end 57 and the point where the power plate protrusion 94 is obstructed by the base plate upper end 55. When the power plate 94 is proximate the base plate lower end 57, the power plate 94 is in the cocked position. When the power plate 94 is proximate the base plate upper end 55, the power plate 94 is in the fired position. Power plate 94 may be made from a materials comprising steel, aluminum, a hybrid nylon glass filled or any other material that satisfies strain and stress requirements of a particular application.

Power spring 96 is positioned adjacent the inboard surface of power plate 74. Power spring 96 engages power plate boss 88 and power spring brace 65. Power spring 96 urges power plate 74 to rotate from the cocked position to the fired position. In the illustrated embodiment, power spring 96 is generally in the shape of the Greek letter omega (Ω). A power spring having this shape is advantageous because when such a spring is positioned adjacent the power plate 74, power spring 96 does not obstruct power plate central axis aperture 76. Springs having other shapes may also be utilized. Preferably, such other springs will not obstruct the power plate central axis aperture 76. Power spring 96 may be made of materials comprising steel, aluminum, a hybrid nylon glass filled or any other material that satisfies strain and stress requirements of a particular application. Power spring 96 may have any spring coefficient that is sufficient to meet the requirements of the particular application for which the spring is used. When power spring 96 is in position adjacent power plate 74 and when actuator assembly 42 is attached to vehicle seat assembly 20, power spring 96 is disposed within a cavity bounded on an inboard side by the outer surface of latch assembly 30, bounded on an outboard side by power plate 74 and at least partially surrounded by a portion of base plate 54.

Power plate extension 82 is positioned adjacent the inboard surface of power plate 74 and rigidly connected thereto. As illustrated in FIG. 2A, in at least one embodiment, power plate extension 82 is in the general shape of a shallow cylinder. Power plate extension 82 has a power plate extension central axis aperture 98 extending from an outboard surface of power plate extension 82 through to an inboard surface of power plate extension 82. Power plate extension 82 has power plate extension teeth 100 disposed along the perimeter of the power plate extension central axis aperture 98. Power plate extension 82 further includes base plate mounting apertures 102 and trigger plate retaining member mounting apertures 104 extending from the inboard surface of power plate extension 82 through to the outboard surface of power plate extension 82. In the illustrated embodiment, power plate extension 82 is positioned adjacent power plate 74 such that the power plate extension teeth 100 are in register with the power plate teeth 86. Additionally, the power plate mounting apertures 102 are in register with the power plate extension mounting apertures 78 and the trigger plate retaining member mounting apertures 104 on the power plate extension are in register with the trigger plate retaining member mounting apertures 80 on the power plate. In the illustrated embodiment, when power plate extension 82 is mounted to power plate 74, power plate extension 82 rotates together with power plate 74, and power spring 96 at least partially surrounds power plate extension 82 (See FIG. 4). Power plate extension 82 may be made from materials comprising steel, aluminum, a hybrid nylon glass filled or any other material that satisfies strain and stress requirements of a particular application.

Reference plate fasteners 106 secure reference plate 60 to base plate 54. Reference plate fasteners 106 may be screws, bolts, rivets or any other fastener effective to secure reference plate 60 to base plate 54.

Trigger plate 108 is positioned adjacent the outboard surface of reference plate 60. Trigger plate 108 has a trigger plate central axis aperture 110 extending from an outboard surface through to an inboard surface of trigger plate 108. In a preferred embodiment, the trigger plate central axis aperture 110 is circular and has the same diameter as the reference plate central axis aperture 72. Trigger plate 108 has a trigger plate boss 112 protruding in an outboard direction from the outboard surface of trigger plate 108. Trigger plate 108 further includes slot 114. When trigger plate 108 is positioned adjacent to reference plate 60, reference plate boss 66 protrudes through slot 114 and trigger plate central axis aperture 110 is axially aligned with reference plate central axis aperture 72.

Trigger plate 108 further includes three trigger plate ball bearing receptacles 116 (See FIG. 2C). Trigger plate ball bearing receptacles 116 are disposed within the inboard surface of trigger plate 108. Trigger plate ball bearing receptacles 116 include trigger plate ball bearing receptacle inclines 118 that ramp upwards towards the inboard surface of trigger plate 108 in a clockwise direction when viewed in FIG. 2C.

Three ball bearings 120 are disposed at least partially within the respective three reference plate apertures 68 and at least partially within either power plate ball bearing receptacles 90 or the three trigger plate ball bearing receptacles 116, as discussed in greater detail below. In other embodiments, a greater or lesser number of ball bearings 120 may be used with a corresponding increase or decrease in respective ball bearing receptacles in the trigger plate 108 and the power plate 74 and ball bearing apertures in reference plate 60.

As illustrated, trigger plate retaining member 84 is a generally cylindrical member having an outer diameter slightly smaller than the diameter of the trigger plate central axis aperture 110 and the reference plate central axis aperture 72. Trigger plate retaining member 84 further includes a collar receiving groove 122 in the outer surface of trigger plate retaining member 84. Trigger plate retaining member 84 further includes a trigger plate retaining member central axis aperture 124 extending from the outboard surface through to the inboard surface of trigger plate retaining member 84. In the illustrated embodiment, the trigger plate retaining member central axis aperture 124 is axially aligned with the trigger plate central axis aperture 110 and the reference plate central axis aperture 72 and the power plate central axis aperture 76 and the power plate extension central axis aperture 98. Trigger plate retaining member 84 is disposed within the trigger plate central axis aperture 110 and within the reference plate central axis aperture 72 such that the inboard surface of the trigger plate retaining member 84 is adjacent to the outboard surface of power plate 74. Trigger plate retaining member 84 is secured to power plate 74 through the use of fasteners 106. Power plate extension 82 is secured to the inboard surface of power plate 74 through the use of fasteners 107. Trigger plate retaining member 84 can be made from materials comprising steel, aluminum, a hybrid nylon glass filled or any other material that satisfies strain and stress requirements of a particular application.

Collar 126 is a ring-shaped member that can be made of materials comprising steel, aluminum, a hybrid nylon glass filled or any other material that satisfies strain and stress requirements of a particular application. Collar 126 is partially seated within collar receiving groove 122 such that a portion of collar 126 extends radially outward from collar receiving groove 122 and thus obstructs movement of trigger plate 108 in the outboard direction.

In the illustrated embodiment, trigger plate 108 may rotate with respect to reference plate 60 about trigger plate retaining member 84. The rotation of trigger plate 108 is limited by the obstruction formed between reference plate boss 66 and the internal surface at one end of slot 114.

Trigger spring 128 is positioned adjacent the outboard surface of trigger plate 108. Trigger spring 128 engages trigger plate boss 112 at one end. Trigger spring 128 also engages trigger plate retaining member 84 along a central portion. Trigger spring 128 also engages reference plate boss 66 at an end opposite the end that engages trigger plate boss 112. Trigger spring 128 is compressed when positioned as described above. When compressed, trigger spring 128 urges trigger plate 108 to rotate in a clockwise direction when viewed in FIGS. 2A and 3.

FIG. 3 is a perspective view of actuator assembly 42 illustrated in FIG. 2A. This view illustrates how the various components of the actuator assembly 42 are positioned when actuator assembly 42 is assembled. As illustrated, the actuator assembly 42 is a layered construction with the base plate 54 occupying the most inboard position, the reference plate 60 outboard of base plate 54, and the trigger plate 108 outboard of reference plate 60. The trigger plate retaining member 84 is positioned so that an outboard portion protrudes through the trigger plate central axis aperture 110 in an outboard direction and the collar 126 is disposed within the collar receiving groove 122 to prevent the trigger plate 108 from moving in an outboard direction. The trigger spring 128 is disposed outboard of the trigger plate 108 and is held in position by cooperation of the trigger plate boss 112, the trigger plate retaining member 84 and the reference plate boss 66.

The trigger plate boss 112, reference plate boss 66, and trigger plate retaining member 84 cooperate to compress trigger spring 128. The trigger spring 128, acting on trigger plate boss 112, urges trigger plate 108 to rotate in the clockwise direction when viewed in FIG. 3. Trigger plate 108 is inhibited from rotating under the urging of trigger spring 128 in the clockwise direction (when viewed in FIG. 3) by the cooperation of slot 114 with reference plate boss 66. When trigger plate 108 is in the position where further clockwise rotation is prevented by the cooperation of slot 114 with reference plate boss 66, trigger plate 108 is in the hold position. When force is applied to trigger plate 108 in a counterclockwise direction (when viewed in FIG. 3) that is sufficient to overcome the force applied by trigger spring 128, trigger plate 108 will rotate in the counterclockwise direction. The counterclockwise rotation will be limited by the length of slot 114. When trigger plate 108 is in the position where further counterclockwise rotation is inhibited by the cooperation of slot 114 with reference plate boss 66, trigger plate 108 is in the release position. In other embodiments, trigger plate 108 may reach the release position before the point where further clockwise rotation is inhibited by cooperation of the slot 114 with reference plate boss 66.

FIG. 4 illustrates a bottom elevational view of actuator assembly 42 and shows the respective positions of power plate 74, power spring 96, power plate extension 82, and base plate 54. Power spring 96 is held in compression by the cooperation of power plate boss 88 and power spring brace 65. In this configuration, power spring 96 urges power plate 74 to rotate towards the fired position.

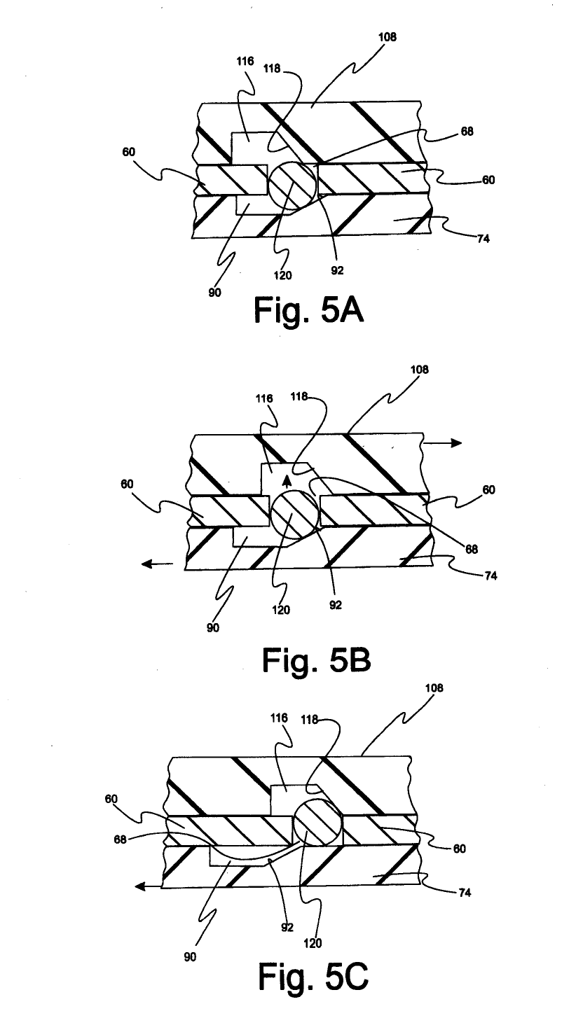

Operation of the actuator assembly will now be described. With reference to FIGS. 5A-C, ball bearings 120 cooperate with the power plate ball bearing receptacles 90, the trigger plate ball bearing receptacles 116, and the reference plate ball bearing apertures 68 to control the movement of the power plate 74 from the cocked position to the fired position. When the power plate 74 is in the cocked position (FIG. 5A), the power plate ball bearing receptacles 90 are at least partially aligned with the reference plate ball bearing apertures 68 and the ball bearings 120 are disposed at least partially within the reference plate ball bearing apertures 68 and at least partially within the power plate ball bearing receptacle 90. As set forth above, when power plate 74 is in the cocked position, it is urged by power spring 96 to move from the cocked position to the fired position. As a consequence of the urging of power spring 96, power plate ball bearing receptacle incline 92 urges ball bearing 120 out of power plate ball bearing receptacle 90. When trigger plate 108 is in the hold position, the trigger plate ball bearing receptacles 116 are at least partially out of alignment with the reference plate ball bearing apertures 68. Accordingly, ball bearings 120 are obstructed from moving out of the power plate ball bearing receptacles 90. Consequently, ball bearings 120 obstruct rotation of the power plate 74 from the cocked position to the fired position.

When a force is applied to the trigger plate 108 in a counterclockwise direction (when viewed in FIG. 4) that is sufficient to overcome the force of trigger spring 128, trigger plate 108 will move from the hold position to the released position. See FIG. 5B. When trigger plate 108 is in the released position, trigger plate ball bearing apertures 116 comes into at least partial alignment with reference plate ball bearing apertures 68 and thus no longer obstruct movement of ball bearings 120 out of the power plate ball bearing apertures 90. The force acting on the ball bearings 120 by the power plate ball bearing aperture inclines 92 cause ball bearings 120 to move into the trigger plate ball bearing apertures 116 and out of power plate ball bearing receptacles 90. When the ball bearings 120 are no longer disposed between the reference plate ball bearing apertures 60 and the power plate ball bearing receptacles 90, power plate 74 is no longer obstructed from rotation. Accordingly, power plate 74 rotates from the cocked position to the fired position under the urging of power spring 96. While the power plate 74 in the fired position, the power plate ball bearing receptacles 90 are at least partially out of alignment with the reference plate ball bearing receptacles 68 (See FIG. 5C).

When the force that caused the trigger plate 108 to rotate from the hold position to the released position is discontinued, trigger plate 108 is urged to rotate back towards the hold position under the force exerted by trigger spring 128. As trigger plate 108 attempts to rotate back to the hold position, trigger plate ball bearing receptacle inclines 118 exert force on ball bearings 120 urging ball bearings 120 out of trigger plate receptacles 116. Movement of ball bearings 120 out of trigger plate receptacles 116 is obstructed by the at least partial non-alignment of the power plate ball bearing receptacles 90. When power plate 74 is rotated back to the cocked position, the power plate ball bearing receptacles 90 are once again at least partially aligned with reference plate ball bearing apertures 60. This alignment permits ball bearings 120 to at least partially move back into power plate ball bearing receptacles 90 under the urging of the force exerted by the trigger plate ball bearing aperture inclines 118, thus clearing the obstruction that had prevented trigger plate 108 from returning to the hold position. Trigger plate 108 thus returns to the hold position under the urging of trigger spring 128.

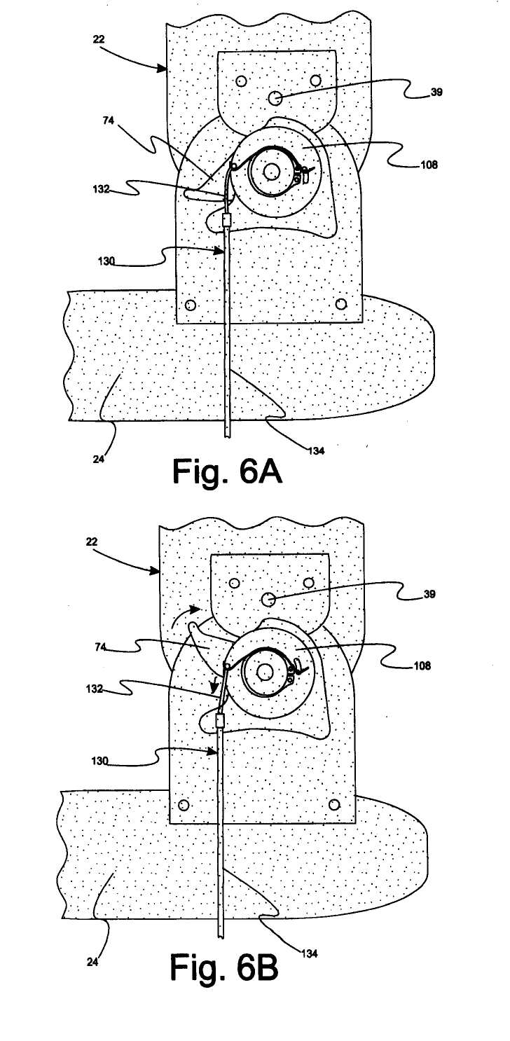

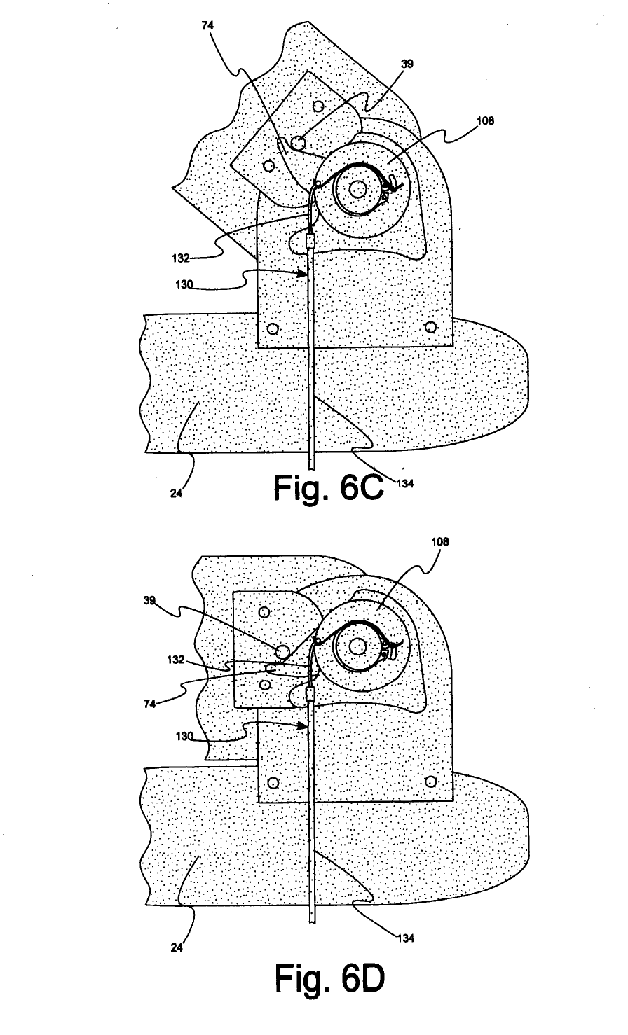

With reference to FIG. 6A, the actuator assembly 42 is mounted to the vehicle seat assembly 20. Seat back assembly 22 is illustrated in an upright position. Actuator assembly 42 is shown with the power plate 74 in the cocked position. Wire assembly 130 including wire 132 and sleeve 134 is connected to trigger plate 108. Trigger plate 108 is shown in the hold position. Cocking member 39 is illustrated directly above actuator assembly 42. In other embodiments, cocking member 39 may be positioned elsewhere with respect to actuator assembly 42. Cocking member 39 may be connected to seat back assembly 22, to latch assembly 30 or elsewhere on vehicle seat assembly 20.

With reference to FIG. 6B, wire assembly 130 pull on trigger plate 108 causing trigger plate 108 to rotate from the hold position to the released position. Once the trigger plate 108 reaches the release position, power plate 74 moves from the cocked position to the fired position under the urging of power spring 96. As power plate 74 and power plate extension 82 rotate from the cocked position to the fired position, power plate 74 and power plate extension 82 engage and rotate the latch release mechanism 34 causing the latch assembly 30 to release. The release of the latch assembly 30 causes the seat back assembly 22 to fold over seat bottom 24 under the urging of vehicle seat spring 40. Power plate 74 remains in the fired position under the urging of power spring 96, which, in turn, maintains the latch assembly 30 in a released state.

With reference to FIG. 6C, seat back assembly 22 is shown as it moves from an upright position to a folded position. As seat back assembly 22 folds, cocking member 39 is brought into engagement with power plate protrusion 94. As seat back assembly 22 continues folding, cocking member 39 applies a force to power plate protrusion 94 in a counterclockwise direction (when viewed in FIG. 6c) that is sufficient to overcome the force of power spring 96. This causes power plate 74 to rotate back towards the cocked position.

With reference to FIG. 6D, the seat back assembly 22 is illustrated in the folded position. In this position, power plate 74 is returned to the cocked position and the actuator assembly 42 is reset.

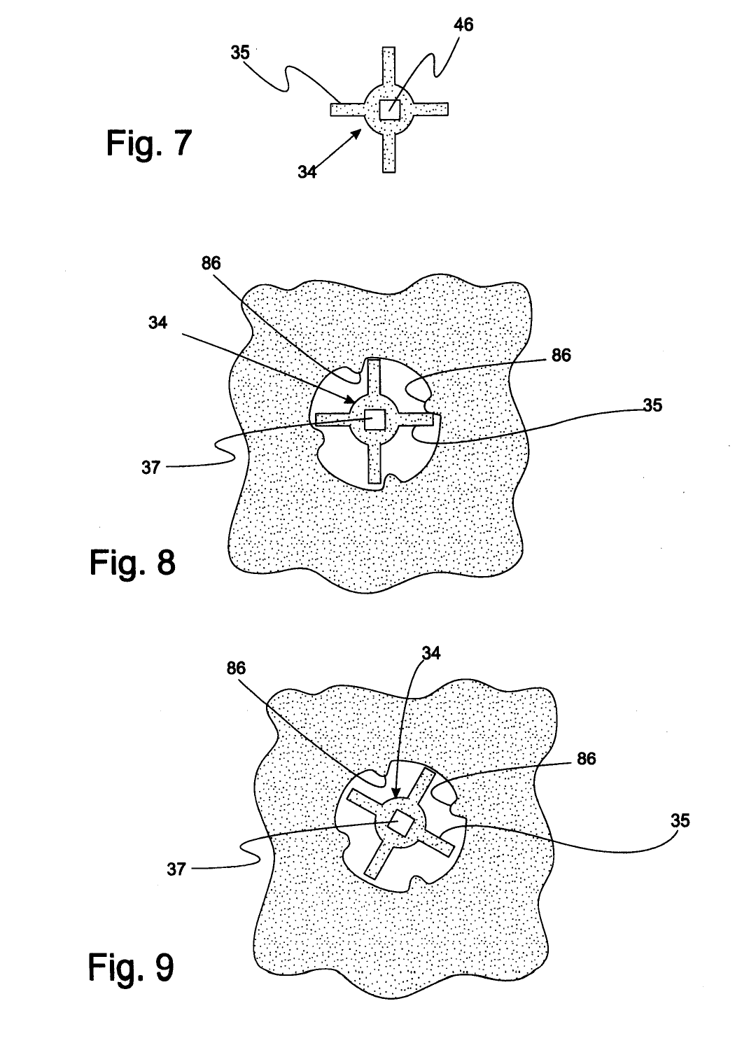

FIG. 7 illustrates an embodiment of latch release mechanism 34. As illustrated, a plurality of ridges 35 are positioned around an outer perimeter of latch release mechanism 34. As will be discussed below, ridges 35 are engaged by the power plate teeth 86 and by the power plate extension teeth 100 when power plate 74 rotates from the cocked position to the fired position.

Latch release mechanism 34 has an opening 46 which receives coupling portion 50. Opening 46 is configured to be engaged by coupling portion 50 such that when an operator pulls on handle portion 52, torque is transmitted by coupling portion 50 to latch release mechanism 34 causing latch release mechanism 34 to rotate when latch release mechanism 34 rotates, latch assembly 30 is released.

FIG. 8 illustrates the engagement of latch release mechanism 34 by power plate 74 and power plate extension 82 (not shown). As illustrated in FIG. 8, the power plate teeth 86 are positioned approximately adjacent to the counterclockwise side of ridges 35. As power plate 74 rotates clockwise, power plate teeth 86 will engage the ridges 35 and cause latch release mechanism 34 to rotate in a clockwise direction (when viewed in FIG. 8).

As shown in FIG. 9, because the power plate teeth 86 are positioned adjacent to the counterclockwise side of ridges 35, latch release mechanism 34 may be at least partially rotated in a clockwise direction without obstruction by power plate teeth 86. Configured in this manner, latch release mechanism 34 may be actuated by handle assembly 48 without obstruction by actuator assembly 42. In the illustrated embodiment, latch release mechanism includes four ridges and power plate 74 includes four power plate teeth 86. In other embodiments, a lesser or number of power plate teeth and a lesser or greater number of ridges may be utilized.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An actuator assembly for use with a seat assembly having a latch assembly, the latch assembly having a handle portion and a latch release mechanism configured to move between a locked position and a released position, the latch assembly preventing movement of one portion of the seat assembly with respect to another portion of the seat assembly when the latch release mechanism is in the locked position, the latch assembly permitting movement of the one portion of the seat assembly with respect to the other portion of the seat assembly when the latch release mechanism is in the released position, the latch release mechanism being manually operable by the handle portion, the actuator assembly comprising:
a base plate adapted to be positioned on the seat assembly proximate the latch release mechanism; and
an actuator connected to the base plate, the actuator being capable of moving the latch release mechanism from the locked position to the released position, and the actuator being configured to avoid obstructing manual operation of the latch assembly by the handle.

2. The actuator assembly of claim 1 wherein the actuator is adapted to engage the vehicle seat assembly as the one portion of the seat assembly moves with respect to the other portion of the seat assembly such that the latch assembly can be reset.

3. The actuator assembly of claim 1 wherein the actuator includes a component connected to the actuator, the component being configured to move back and forth between a cocked position and a fired position, the component being configured to engage the latch release mechanism such that the component moves the latch release mechanism from the locked position to the released position as the component moves from the cocked position to the fired position.

4. The actuator assembly of claim 3 wherein the component is adapted to engage the vehicle seat assembly as the one portion of the seat assembly moves with respect to the other portion of the seat assembly such that the component is moved from the fired position to the cocked position.

5. The actuator assembly of claim 3, the latch release mechanism having a ridge along a perimeter of the latch release mechanism, wherein the component has a tooth capable of engaging the ridge and wherein the component is capable of moving the latch release mechanism from the locked position to the released position by cooperation of the tooth and the ridge.

6. The actuator assembly of claim 1 further comprising an elongated linkage attached to the actuator to enable remote actuation of the actuator.

7. A vehicle seat assembly in combination with an actuator assembly, the combination comprising:
a seat assembly having a seat back, a seat bottom connected to the seat back and a latch assembly connected to the seat back, the latch assembly having a handle portion and a latch release mechanism configured to move between a locked position and a released position, the latch assembly preventing movement of the seat back with respect to the seat bottom when the latch release mechanism is in the locked position, the latch assembly permitting movement of the seat back with respect to the seat bottom when the latch release mechanism is in the released position, the latch release mechanism being manually operable by the handle portion; and
an actuator assembly connected to the seat assembly, the actuator assembly having a base plate connected to the seat assembly proximate the latch release mechanism, and an actuator connected to the base plate, the actuator moving the latch release mechanism from the locked position to the released position when the actuator is actuated, and the actuator being configured to avoid obstructing manual operation of the latch assembly by the handle.

8. The combination of claim 7 wherein the seat assembly further comprises a cocking member connected to the seat assembly wherein the cocking member engages the actuator as the seat back moves with respect to the seat bottom such that the latch assembly is reset.

9. The combination of claim 8 wherein the actuator includes a component connected to the actuator, the component being configured to move back and forth between a cocked position and a fired position, the component being configured to engage the latch release mechanism such that the component moves the latch release mechanism from the locked position to the released position as the component moves from the cocked position to the fired position.

10. The combination of claim 9 wherein the latch release mechanism has a ridge along a perimeter of the latch release mechanism, and wherein the component has a tooth capable of engaging the ridge, the component moving the latch release mechanism from the locked position to the released position by cooperation of the tooth and the ridge.

11. The combination of claim 10 wherein the actuator assembly further includes an elongated linkage attached to the actuator to enable remote actuation of the actuator and wherein the component includes a protrusion which engages the cocking member as the seat back moves with respect to the seat bottom such that the cocking member and the protrusion cooperate to move the component from the fired position to the cocked position.

12. An actuator assembly for use with a vehicle seat assembly having a seat bottom, a seat back connected to the seat bottom, a spring connected to the vehicle seat assembly urging one portion of the vehicle seat assembly to move with respect to another portion of the vehicle seat assembly and a latch assembly connected to the vehicle seat assembly to restrict such movement, the actuator comprising:
a base plate attachable to the vehicle seat assembly and positionable over the latch assembly;
a reference plate connected to the base plate;
a power plate positioned adjacent a side of the reference plate and proximate the latch assembly when the base plate is positioned over the latch assembly, the power plate being configured for movement with respect to the reference plate between a cocked position and a fired position, and the power plate being configured to avoid obstructing manual operation of the latch assembly;
a power spring engaging the power plate, the power spring urging the power plate towards the fired position;
a trigger plate positioned adjacent to another side of the reference plate and configured for movement with respect to the reference plate between a hold position and a release position; and
a trigger spring engaging the trigger plate, the trigger spring urging the trigger plate towards the hold position,
the power plate being inhibited from moving to the fired position when the trigger plate is in the hold position, the power plate moving from the cocked position to the fired position and being retained in the fired position by the power spring when the trigger plate is in the release position, the power plate being capable of engaging the latch assembly and causing the latch assembly to release when the power plate moves from the cocked position to the fired position, the power plate being capable of retaining the latch assembly in a released state while the power plate is in the fired position.

13. The actuator assembly of claim 12, the vehicle seat assembly having a cocking member, wherein a portion of the power plate is capable of engaging the cocking member as one portion of the vehicle seat assembly moves with respect to another portion of the vehicle seat assembly such that the power plate can be returned to the cocked position.

14. The actuator assembly of claim 13 wherein the power plate has a protrusion capable of engaging the cocking member whereby the power plate can be returned to the cocked position by cooperation of the cocking member and the protrusion.

15. The actuator assembly of claim 12, the latch assembly having a latch release member configured for movement between a locked position and a released position, the latch assembly further having a handle connected to the latch release member to permit manual operation of the latch assembly, wherein the base plate is capable of being positioned over the latch release member, wherein the power plate is capable of engaging the latch release member to move the latch release member between the locked position and the released position and wherein the power plate is configured to avoid obstruction of manual operation of the latch assembly.

16. The actuator assembly of claim 15, the latch release member having a ridge disposed along a perimeter of the latch release member, wherein the power plate has a tooth that is capable of cooperating with the ridge to move the latch release member from the locked position to the released position when the power plate moves from the cocked position to the fired position.

17. The actuator assembly of claim 12, further comprising an extending member connected to the power plate, the extending member being positioned inboard of the power plate with respect to the latch assembly and being capable of engaging the latch assembly and causing the latch assembly to release when the power plate moves from the cocked position to the fired position.

18. The actuator assembly of claim 12 further comprising a ball bearing, wherein the reference plate has a ball bearing aperture, wherein the ball bearing is at least partially received within the ball bearing aperture, wherein the power plate has a power plate ball bearing receptacle for at least partially receiving the ball bearing, wherein the trigger plate has a trigger plate ball bearing receptacle for at least partially receiving the ball bearing, wherein the power plate ball bearing receptacle has an incline that urges the ball bearing out of the power plate ball bearing receptacle as the power plate moves from the cocked position to the fired position, wherein the trigger plate ball bearing receptacle has an incline that urges the ball bearing out of the trigger plate ball bearing receptacle as the trigger plate moves from the release position to the hold position, wherein the ball bearing is free to at least partially move between the power plate ball bearing receptacle and the trigger plate ball bearing receptacle when the power plate ball bearing receptacle and the trigger plate ball bearing receptacle are both substantially aligned with the ball bearing aperture, wherein the trigger plate ball bearing receptacle and the power plate ball bearing receptacle are both substantially aligned with the ball bearing aperture when the power plate is in the cocked position and the trigger plate is in the release position, wherein the ball bearing is positioned at least partially between the power plate ball bearing receptacle and the ball bearing aperture thereby obstructing movement of the power plate from the cocked position to the fired position when the trigger plate is in the hold position and wherein the ball bearing is positioned at least partially between the trigger plate ball bearing receptacle and the ball bearing aperture thereby preventing movement of the trigger plate from the release position to the hold position when the power plate is in the fired position.

19. The actuator assembly of claim 12 further comprising a tether connected to the trigger plate such that trigger plate moves from the hold position to the release position when the tether is pulled.

20. The actuator assembly of claim 20 wherein the tether includes a cable assembly comprising a cable mounted inside of a sleeve, the cable being moveable with respect to the sleeve, and the cable being connected to the trigger plate.
